(19) United States
(12) Patent Application Publication
(10) Pub. No.: US 2007/0091788 A1
(43) Pub. Date: Apr. 26, 2007

(54) Versatile data rate control for enhanced EVDO systems

(75) Inventors: Purva R. Rajkotia, Plano, TX (US); Sanjaykumar Kodali, Plano, TX (US); Chanakya Bandyopadhyay, Richardson, TX (US); Rajasimman Vijayasimman, Richardson, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/431,198

(22) Filed: May 10, 2006

Related U.S. Application Data
(60) Provisional application No. 60/728,523, filed on Oct. 20, 2005.

(51) Int. Cl. H04J 11/00

(52) U.S. Cl. 370/209

(57) ABSTRACT

A system for providing parallel, concurrent transmission of multiple DRC elements is disclosed. An assignment element assigns, for each access terminal in an access network, two DRC-related parameters. A first parameter is assigned to uniquely identify a given access terminal. A second parameter is assigned to identify DRC traffic for that access terminal. An allocation message, such as a traffic channel allocation message, is modified to communicate the parameters from the access network to an access terminal. The access terminal processes its DRC traffic with both parameters, enabling the access network to identify its transmissions regardless of time multiplexing.

### CROSS-REFERENCE TO RELATED APPLICATION AND CLAIM OF PRIORITY

The present application is related to U.S. Provisional Patent No. 60/728,523, filed Oct. 20, 2005, entitled “DRC Enhancements For Evolved DO Systems”. U.S. Provisional Patent No. 60/728,523 is assigned to the assignee of the present application and is hereby incorporated by reference into the present disclosure as if fully set forth herein. The present application hereby claims priority under 35 U.S.C. §119(e) to U.S. Provisional Patent No. 60/728,523.

### TECHNICAL FIELD OF THE INVENTION

The present invention related generally to wireless communication devices and, more specifically, to constructs and methods for optimizing efficiency and capacity in an Enhanced Evolution-Data Only (EEVDO)-based wireless communication system.

### BACKGROUND OF THE INVENTION

Evolution-Data Only, often abbreviated as EV-DO, 1xEV-DO, or EVDO is a wireless broadband data standard that has been adopted by a number of CDMA service providers throughout the world as part of the CDMA2000 family of standards. Initially, EVDO was developed in response to needs for high data rate transmissions in wireless systems. As provider and user needs and demands have increased over time, revisions of EVDO have proposed various enhancements and optimizations. The most recent of these proposed revisions has commonly been referred to as enhanced EVDO (EEVDO).

Under current and proposed EVDO and EEVDO standards, an access terminal (AT) uses a Data Rate Control (DRC) message or signal in the reverse traffic channel to indicate to an access network (AN) a selected serving sector and requested data rate that the AT requires or desires on the forward traffic channel. For each sector in an active set of the AT, the AT is given a corresponding DRC Walsh cover (e.g., a 3-bit value). The AT, when in a connected state, constantly monitors transmission conditions—frequently represented by the channel-to-interference (C/I) ratio—of the pilot channel for all sectors that are in its active set.

Based on the C/I a measurement it makes, an AT selects an optimal or favorable serving sector from which it can receive forward traffic channel at a highest possible DRC rate. The corresponding Walsh cover of this sector is then used to spread DRC symbols transmitted by the AT. Since these Walsh covers are orthogonal to each other, the AN is capable of determining the sector selected by the AT. The now-selected sector will schedule a user traffic packet, and send it via the forward traffic channel, at the rate requested by the AT through its 4-bit DRC value.

Unfortunately, however, there is only one DRC channel in the reverse direction. DRC information for different forward channels must be time multiplexed. This time-multiplexing of the DRC channel results in DRC information for one channel transferred less frequently—potentially waiting for an entire cycle of other DRC transmission. This results in non-optimal DRC sensitivity, and may result in lower system throughput.

As a result, there is a need for a system that provides parallel, concurrent transmission of multiple DRC elements, optimizing system sensitivity to changing transmission conditions and improving overall system efficiency, utilization and capacity.

### SUMMARY OF THE INVENTION

A versatile scheme provides parallel, concurrent transmission of multiple DRC elements by providing a plurality of parameters (i.e., Walsh functions) to differentiate sectors and access terminals. Separate and distinguishable parameters are applied to each access terminal DRC stream, by which an access network may individually identify DRC for that access terminal. Multiple users need not remain time multiplexed, and may thus transmit DRC information concurrently—providing optimal transmission efficiency and capacity without having a negative impact on the sensitivity and throughput of the system.

Specifically, the system of the present disclosure defines an assignment element or construct that assigns, for each access terminal in a system, two DRC-related parameters. A first parameter is assigned to uniquely identify a given access terminal. A second parameter is assigned to identify DRC traffic for that access terminal. An allocation message, such as a traffic channel allocation message, is modified to communicate the parameters from the access network to an access terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “element”, “construct” or “component” may mean any device, system or part thereof that performs a processing, control or communication operation; and such a device may be implemented in hardware, firmware or software, or some combination of at least two of the same. It should be noted that the functionality associated with any particular construct or component may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates one embodiment of a wireless network in which concurrent DRC transmission may be provided according to the principles of the present disclosure;

FIG. 2 depicts one embodiment of a traffic allocation message segment according to certain aspects of the present disclosure; and

FIG. 3 depicts one embodiment of a DRC processing operation according to certain aspects of the present disclosure.

### DETAILED DESCRIPTION OF THE INVENTION

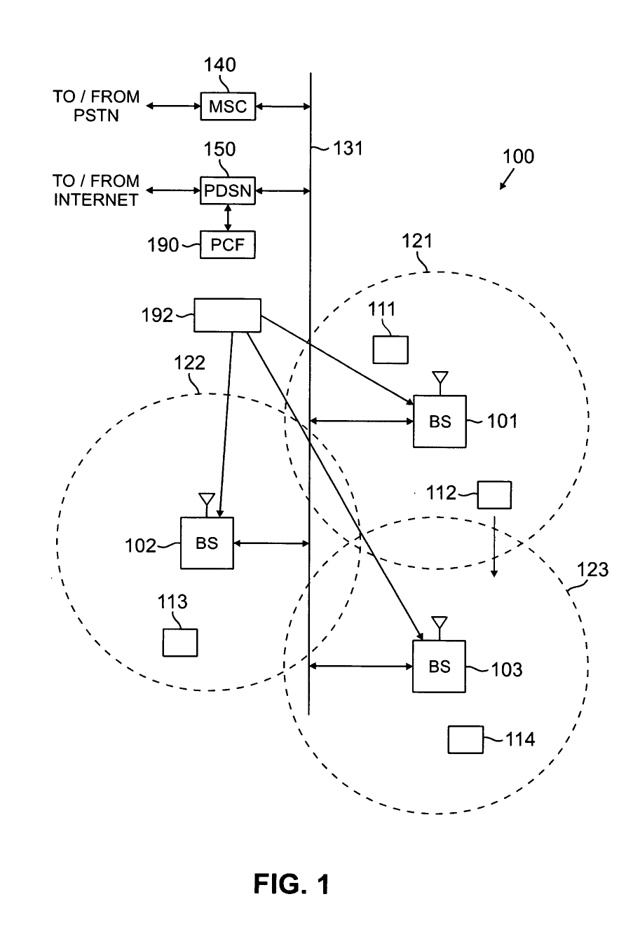

FIGS. 1-3, discussed below, and the various embodiments used to describe the principles of the present disclosure in this patent document are by way of illustration only, and should not be construed in any way to limit the scope of the disclosure. Hereinafter, certain aspects of the present disclosure are described in relation to illustrative embodiments and operations of wireless communications systems and networks. Those skilled in the art, however, will understand that the principles and teachings of the present disclosure may be implemented in a variety of suitably arranged wireless communications devices or systems—regardless of the specific form factor, location, or functionality of that device or system.

The following discloses a system in which parallel, concurrent transmission of multiple DRC elements is provided, using a plurality of parameters (i.e., Walsh functions) to differentiate sectors and access terminals. Separate and distinguishable parameters are applied to each access terminal DRC stream, by which an access network may individually identify DRC for that access terminal. Multiple users need not remain time multiplexed, and may thus transmit DRC information concurrently—providing optimal transmission efficiency and capacity without having a negative impact on the sensitivity and throughput of the system.

Specifically, the system of the present disclosure defines an assignment element or construct within a wireless communications system. The assignment element assigns, for each access terminal in a system, two DRC-related parameters. A first parameter is assigned to uniquely identify a given access terminal. A second parameter is assigned to identify DRC traffic for that access terminal. An allocation message, such as a traffic channel allocation message, is modified to communicate the parameters from the access network to an access terminal.

For purposes of explanation and illustration, the methods and operations of the present disclosure are described hereafter in reference to various operational aspects of EVDO and EEVDO systems, as defined by applicable CDMA2000 standards and proposals—i.e., 3GPP2 1xEV-DO through 1xEV-DO Rev. B. Those standards and proposals are hereby incorporated by reference.

Under conventional systems, as previously noted, an access terminal (AT) uses a Data Rate Control (DRC) message or signal in the reverse traffic channel to indicate to an access network (AN) a selected serving sector and requested data rate that the AT requires or desires on the forward traffic channel. For each sector in an active set of the AT, the AT is given a corresponding DRC Walsh cover (e.g., a 3-bit value). The AT, when in a connected state, constantly monitors transmission conditions—frequently represented by the channel-to-interference (C/I) ratio—of the pilot channel for all sectors that are in its active set.

Based on the C/I measurement it makes, an AT selects an optimal or favorable serving sector from which it can receive forward traffic channel at a highest possible DRC rate. The corresponding Walsh cover of this sector is then used to spread DRC symbols transmitted by the AT. Since these Walsh covers are orthogonal to each other, the AN is capable of determining the sector selected by the AT. The now-selected sector will schedule a user traffic packet, and send it via the forward traffic channel, at the rate requested by the AT through its 4-bit DRC value.

The DRC value is sent in every slot (e.g., every 1.67 msec). Depending on the value on the length of the DRC cycle (for all ATs) sent by the AN in the traffic channel assignment, the value of the DRC and DRC cover may not be changed for a duration corresponding to that length. For example, if DRCLength=1, the AT will select a new DRC value and DRC cover in every slot. If DRCLength=4, the AT will select a new DRC value and DRC cover once every 4 slots. Regardless of the value of DRCLength, however, the DRC value and DRC cover are sent in every slot. In the DRCLength=4 example, the same DRC value and DRC cover are used in each of the 4 slots that comprise the DRCLength. The same DRC set (Cover+value) is sent in every slot, over the duration of DRCLength number of slots.

Unfortunately, as previously noted, time-multiplexing of the DRC channel results in DRC information for one channel transferred less frequently—potentially waiting for an entire cycle of other DRC transmission. This results in non-optimal DRC sensitivity, and may result in lower system throughput. In contrast, the system of the present disclosure provides for concurrent DRC transmissions from multiple ATs in the same time slot.

Referring now to FIG. 1, one illustrative embodiment of a wireless access network 100, according to certain aspects of the present disclosure, is depicted. Access network (AN) 100 comprises a plurality of cells (or cell sites) 121-123, each containing one of a plurality of base stations, BS 101, BS 102, or BS 103. Base stations 101-103 communicate with a plurality of access terminals (AT) 111-114, over code division multiple access (CDMA) channels according to, for example, the IS-2000 standard (i.e., CDMA2000). In an advantageous embodiment of the present disclosure, access terminals 111-114 are capable of receiving data traffic and/or voice traffic on two or more CDMA channels simultaneously. Access terminals 111-114 may be any suitable wireless devices (e.g., conventional cell phones, PCS handsets, personal digital assistant (PDA) handsets, computers, telemetry devices) that are capable of communicating with base stations 101-103 via wireless links. Access terminals 111-114 are not limited to mobile devices. The present disclosure also encompasses other types of wireless access terminals, including fixed wireless terminals.

Dotted lines show the approximate boundaries of cells (or cell sites) 121-123 in which base stations 101-103 are located. It is noted that the terms “cells” and “cell sites” may be used interchangeably in common practice. For simplicity, the term “cell” will be used hereafter. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In one embodiment of the present disclosure, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103. AN 100 further comprises an assignment element 192. Element 192 is communicatively linked with BS 101-103, and may be distributed or discrete in nature. Element 192 is operable to determine which parameters are assigned to each AT.

Communication line 131 may be any suitable connection means, including a T1 line, a T3 line, a fiber optic link, a network packet data backbone connection, or any other type of data connection. Alternatively, communication line 131 may be replaced by a wireless backhaul system, such as microwave transceivers. Communication line 131 links each vocoder in the BSC with switch elements in MSC 140. The connections on communication line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the mobile stations in a wireless network and external networks, such as the PSTN or Internet. MSC 140 is well known to those skilled in the art. In some embodiments, communication line 131 may be several different data links where each data link couples one of BS 101, BS 102, or BS 103 to MSC 140. For ease of reference, BS 101, BS 102, BS 103, MSC 140, PDSN 150, PCF 190, and all communication links there between may hereafter be referred to collectively as the access network (AN).

As an AT enters or initializes within the AN, the AN transmits an allocation message—such as a traffic channel allocation message (TCAM)—to the AT on the forward channel. Within this allocation message, the AN specifies two DRC-related parameters for the AT, as determined by the assignment element. A first parameter specified provides a unique identifier for that AT's DRC transmissions. A second parameter specifies provides sector specific DRC channel information to be used by the AT for its transmissions. These parameters may be assigned directly from the AN or, in alternative embodiments, may be provided via a coded look-up table system. In the embodiment illustrated, these parameters comprise 8-bit Walsh functions. For example, the sector specific parameter may be provided as an 8-bit Walsh cover, each chip of which is further spread by an AT specific 8-bit Walsh cover. Other embodiments may provide other bit-length Walsh functions, or other coding schemes for the DRC-related parameters.

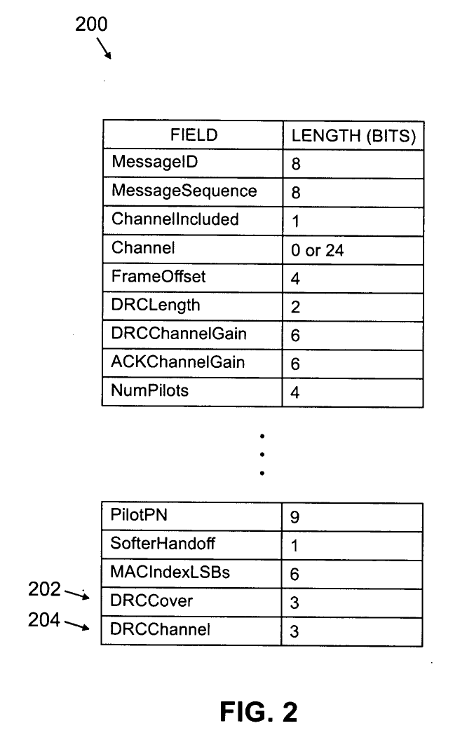

Referring now to FIG. 2, a portion of a traffic channel assignment message (TCAM) 200 is shown having the first and second parameters, 202 and 204, respectively, of the present disclosure. TCAMs similar to TCAM 200 are transmitted in forward channels from the AN to the ATs 111-114. Parameter 202 may define a sector specific parameter—DRCCover—which is provided in this embodiment as an 8-bit Walsh cover. Parameter 204 may define an AT specific parameter—DRCChannel—which is provided in this embodiment as an 8-bit Walsh cover.

Thus, during the connection negotiation process between a wireless access terminal and an access network, the TCAM is supplemented to provide a unique DRC identification to each AT—one which time-independent. Having established a unique DRC identification for each AT, the AN may allow concurrent DRC transmissions from multiple ATs.

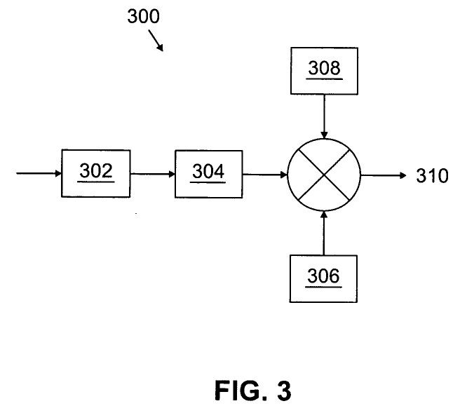

Referring now to FIG. 3, a portion 300 of an AT's RF/baseband processing according to the present system is depicted. The AT's DRC information is processed through encoder 302 and repetition 304 stages. After repetition, a first sector-based parameter 306 (e.g., 8-bit Walsh cover) is applied. A separate, AT-specific second parameter 308 is then applied for each DRC stream. For example, each Walsh chip of an 8-bit Walsh cover may be further spread by an 8 bit Walsh function. After both parameters have been applied to the DRC information, it is transmitted 310 on to a receiving member of the AN (e.g., a BS). Upon receipt of the DRC stream from the AT, the AN can decode it by applying the corresponding parameters it assigned to the AT.

It should be apparent to those of skill in the art that the present disclosure is not limited solely to particular types of wireless communications devices. The present disclosure encompasses a wide variety of fixed and mobile wireless devices (e.g., mobile phones, laptop computers, PDAs)—especially as the functions of such devices converge and evolve. It should therefore be understood that the use of the term “wireless communications device”, “wireless device” or “wireless communications system” in the claims and in the description is intended to encompass a wide range of wireless data and communications components.

Although certain aspects of the present disclosure have been described in relations to specific systems, standards and structures, it should be easily appreciated by one of skill in the art that the system of the present disclosure provides and comprehends a wide array of variations and combinations easily adapted to a number of wireless communications system. As described herein, the relative arrangement and operation of necessary functions may be provided in any manner suitable for a particular application. A number of differentiation parameter formats and combinations may be utilized. All such variations and modifications are hereby comprehended. It should also be appreciated that the constituent members or components of this system may be produced or provided using any suitable hardware, firmware, software, or combination(s) thereof.

The embodiments and examples set forth herein are therefore presented to best explain the present disclosure and its practical application, and to thereby enable those skilled in the art to make and utilize the system of the present disclosure. The description as set forth herein is therefore not intended to be exhaustive or to limit any invention to a precise form disclosed. As stated throughout, many modifications and variations are possible in light of the above teaching without departing from the spirit and scope of the following claims.

What is claimed is:

1. A method of communicating data rate control information between an access terminal and an access network, the method comprising the steps of:
providing a unique first parameter indicating a given sector of the access network;
providing a unique second parameter indicating the access terminal;
communicating the unique first and second parameters from the access network to the access terminal; and
processing data rate control information for the access terminal with the unique first and second parameters prior to transmitting that data rate control information to the access network.

2. The method of claim 1, wherein the access network is an Evolution Data-Only (EVDO) based system.

3. The method of claim 2, wherein the access network is an Enhanced Evolution Data-Only (EEVDO) based system.

4. The method of claim 1, wherein the unique first parameter is a Walsh function.

5. The method of claim 4, wherein the unique first parameter is an 8-bit Walsh cover.

6. The method of claim 1, wherein the unique second parameter is a Walsh function.

7. The method of claim 6, wherein the unique first parameter is an 8-bit Walsh cover.

8. The method of claim 1, wherein the step of communicating the unique first and second parameters from the access network to the access terminal comprises sending an allocation message containing the unique first and second parameters.

9. The method of claim 1, wherein the step of communicating the unique first and second parameters from the access network to the access terminal comprises sending an allocation message containing a look-up table code for the unique first and second parameters.

10. The method of claim 1, wherein the step of processing data rate control information for the access terminal with the unique first and second parameters is performed in the access terminal's RF/baseband processing.

11. A method of providing concurrent utilization of a single data rate control channel in an Evolution Data-Only (EVDO) based system, the method comprising the steps of:
providing an access network;
providing a first and a second access terminal;
providing a unique first parameter indicating the first access terminal, a unique second parameter indicating the second access terminal, and a unique third parameter indicating a given sector of the access network;
communicating the unique first and third parameters from the access network to the first access terminal;
communicating the unique second and third parameters from the access network to the second access terminal;
processing data rate control information for the first access terminal with the unique first and third parameters, and transmitting that data rate control information to the access network; and
processing data rate control information for the second access terminal with the unique second and third parameters prior, transmitting that data rate control information to the access network concurrent with the transmission of the data rate control information for the first access terminal.

12. The method of claim 12, wherein the Evolution Data-Only (EVDO) based system is an Enhanced Evolution Data-Only (EEVDO) based system.

13. The method of claim 11 wherein the unique first parameter comprises a Walsh code.

14. The method of claim 11 wherein the unique second parameter comprises a Walsh code.

15. The method of claim 11 wherein the unique third parameter comprises a Walsh code.

16. The method of claim 11, wherein the steps of communicating the unique parameters from the access network to the access terminals utilizes forward channel communication.

17. The method of claim 11, wherein the steps of transmitting data rate control information to the access network from the access terminals utilize reverse channel communication.

18. A wireless communication system comprising:
an access network;
an assignment element within the access network; and
an access terminal in communication with the access network;
wherein a unique first parameter indicates a given sector of the access network in which the access terminal resides, a unique second parameter is assigned to the access terminal by the assignment element, the unique first and second parameters are communicated from the access network to the access terminal, and data rate control information for the access terminal is processed with the unique first and second parameters prior to transmitting that data rate control information to the access network.

19. The system of claim 18, wherein the access network is an Evolution Data-Only (EVDO) based system.

20. The system of claim 19, wherein the access network is an Enhanced Evolution Data-Only (EEVDO) based system.

21. A wireless access terminal comprising:
a communications link to an access network;
a unique first parameter indicates a given sector of the access network in which the access terminal resides;
a unique second parameter is assigned to the access terminal by the access network; and
a processing function that processes data rate control information with the unique first and second parameters prior to transmitting that data rate control information to the access network.

22. The device of claim 21, wherein the access network is an Evolution Data-Only (EVDO) based system.

23. The device of claim 22, wherein the Evolution Data-Only (EVDO) based system is an Enhanced Evolution Data-Only (EEVDO) based system.
